(19) United States
(12) Patent Application Publication
(10) Pub. No.: US 2011/0240671 A1
(43) Pub. Date: Oct. 6, 2011

(54) DISCHARGING MATERIAL FROM HOPPERS AND THE LIKE

(76) Inventors: James Frances McDiarmid, Swan Hill Road (AU); Graham Reginald Reginald, Brignton East (AU); Vincent Rouillard, Yarraville (AU)

(21) Appl. No.: 12/599,691

(22) PCT Filed: May 12, 2008
(86) PCT No.: PCT/AU08/00653

§ 371 Date: Nov. 10, 2009

(30) Foreign Application Priority Data
May 10, 2007 (AU) 2007902487

(51) Int. Cl. B67D 7/06

(52) U.S. Cl. 222/1; 222/196

(57) ABSTRACT

An apparatus to effect optimum delivery of dry bulk material from a hopper includes a device to provide vibratory stimulus to the hopper. The device for providing vibratory stimulus includes a device to identify the resonant frequency of the hopper and its contents at any time and to automatically continuously vary the frequency of the vibratory stimulus to maintain this frequency at, or close to, the resonant frequency of the hopper and its contents.

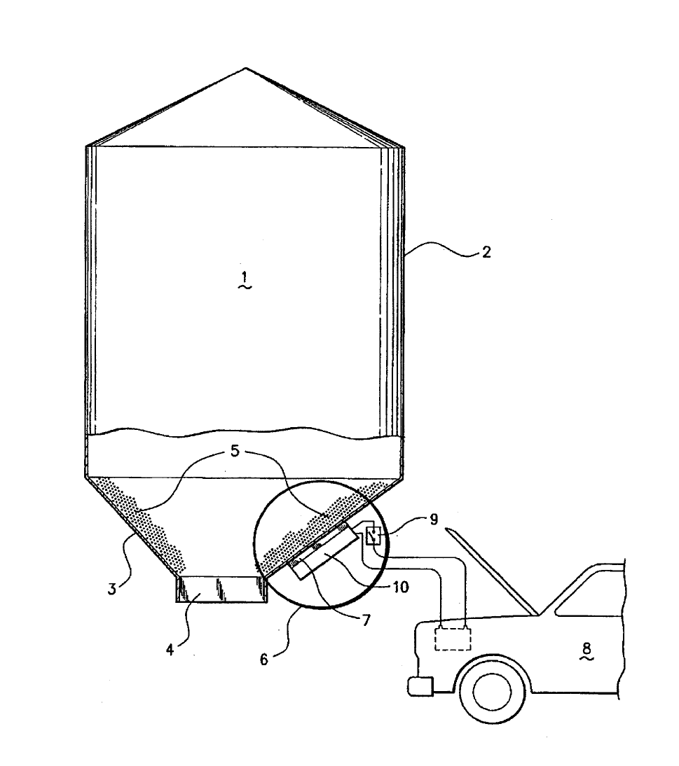

This invention relates to the discharge of material from hoppers, silos or the like which will be referred to herein generally as hoppers.

Grain growers must empty their hoppers—not only because any grain left inside them is inherently valuable, but also because any leftover grain can harbour insect and other pests that can re-infest grains that are harvested and stored the following season. If these insects are detected the grain is rejected by grain dealers and the farmer must disinfest his grain

Many grain hoppers presently in use on farms have hopper bottoms that are very shallow and this makes it difficult to remove the last few hundred kilograms of grain. As a result farmers often resort to heavily striking the hoppers to induce flow. This can physically damage the hopper.

On occasions they can be tempted to enter hoppers to physically move the grain. The results can be disastrous; persons entering the hopper can be at risk of injury, particularly if the auger delivering the material from the hopper is operating.

Further, when dry bulk material such as grain, compounds, chemicals, pharmaceuticals, fertilisers and the like is to be discharged from full or partly filled hoppers, it is found that even where the hopper has been shaped to best facilitate such discharge, the material can cease to flow, as often a void occurs in the material above the outlet because, effectively, an arch of the material is formed. In some applications, it is found that material in the centre of the hopper is delivered and the remainder of the material, which is adjacent the walls of the hopper tends not to slide down the conical lower portion of the hopper and this holds up the material there above.

One solution to the problem is for farmers to use a conventional silo shaker, but there are several impediments to taking this course of action. They are:
Such devices usually operate at a single frequency, namely mains power frequency (50 or 60 Hz) and this can be far from optimal for most structures. These shakers are therefore likely to be ineffective because the energy they supply is restricted by the structure and it is not used to disturb the solid particles in the hopper or hoppers.
Conventional hopper shakers are not portable and they are driven by mains electricity.

There have been proposed systems, including the system of Australian Patent Application No 2004201408 of James Francis McDiarmid, one of the inventors, of providing a vibrator unit in contact with the wall of the hopper, generally close to the outlet thereof, whereby the hopper can be subjected to a vibration, usually in a sonic frequency.

Such arrangements have been found to vary substantially in efficiency depending on the material in the hopper, the quantity of material in the hopper and on the frequency selected.

The object of the invention is to provide a variation of the above system wherein the delivery of material from the hopper is more efficient than has previously been the case.

The invention includes a device to effect optimum delivery of dry bulk material from a hopper including means to provide vibratory stimulus to the hopper, the said means including means to identify the resonant frequency of the hopper and its contents at any time and to automatically continuously vary the frequency of the vibratory stimulus to maintain this at or dose to the resonant frequency of the hopper and its contents.

It will be understood that the variation of the frequency as set out above will ensure optimal transmitted vibration and the most effective disturbance of the contents of the hopper whatever the state of the contents of the hopper.

It is preferred that when the resonant frequency of the hopper is reached, the amplitude of the vibration may be modified to provide by the device the optimum operating conditions of the device and flow of the hopper's contents.

The device includes an accelerometer which measures the vibration of the device, and this the hopper and the frequency of vibration is originally varied until the accelerometer indicates optimal vibration and subsequently, the frequency is varied about this position to maintain optimal vibration notwithstanding the resonant frequency of vibration of the hopper varying depended on the contents thereof and the location of the contents.

The initial frequency of vibration can be from a lower or upper limit, depending on the general characteristics of the hopper and can then be varied upwardly or downwardly until the resonant frequency is reached. During operation the frequency can be automatically varied about this optimum frequency by a pre-determined frequency range to maintain the device operating at the optimal frequency of excitation.

It is generally preferred that the device of the invention be associated with the cone of the hopper to provide optimal excitation close to where blocking may occur.

In order that the invention can be more readily understood, one particular application of the invention will be described in relation to the drawing which is that same as included in the specification of an earlier Australian patent application 2004201408 entitled Hopper Emptying Device and which is included herein simply for an indication of a possible physical arrangement of the device.

Referring to the FIGURE there is a hopper 1 which comprises a substantially cylindrical upper section 2 and a conical lower section 3. The conical lower section 3 is provided with a delivery area 4. Under normal circumstances, the material within the hopper flows to the delivery area to an auger conveyor (not shown) directly beneath the hopper 4. However due to compaction of the material 5 in the lower conical section 3 and/or insufficient slope in the lower section 3 of the hopper, material can be retained within the hopper against the lower walls 3 and not flow.

In order to move or dislodge the material 5 from the hopper walls 3, the device 10 is, in this embodiment, portably mounted to the hopper wall 3. Physically, the vibration unit 6 comprises a mounting plate 7 contacting the hopper walls 3. The mounting plate 7 is preferably held in position by electro-magnets mounted within the plate. The electro-magnets or magnets powered from a portable electric source which may be a 12 or 24 volt DC supply as provided by a battery in a vehicle 8. The power supply passes through a switch 9 which when turned on, allows the electrical power to energise the hopper 1 in the electro-magnets in the plate 7. The use of the electro-magnetic attachment means enables the vibration unit 6 to be easily mounted and dismounted from the conical section of the hopper.

The vibration means 10 which also may be powered from a portable power supply such as a 12 or 24 volt DC supply battery will be described further hereinafter. Although in the drawings the power is DC power obtained from a vehicle, it will be understood that any other DC or AC power source could be used.

The device of the invention includes a microprocessor-controlled device to promote the discharge of hoppers or hopper like structures used to store dry bulk material.

The device is based on providing a suitable vibratory stimulus to the structure resulting in the disturbance of the product and thus promoting flow of the product. The device meets a practical need to a wide range of industries which rely on the effective handling of dry granular material such as, but not limited to the use in food processing, pharmaceutical manufacturing, chemical manufacturing, grain storage and bulk transport.

The operation of the device is that it exploits the principle that every structure possesses distinct mechanical resonances at specific natural frequencies.

When applied to hoppers, under resonance conditions, the structure has a tendency to vibrate at optimal levels which results in disturbances at the interface with the granular material. This, coupled with the influence of gravity, promotes the downward flow of the material. The main desiderata of the device is to control the frequency and amplitude of the vibration device or devices in such a way that optimal resonance conditions in the hopper or hopper like structures are maintained throughout the period during which the hopper is being emptied.

The device incorporates an accelerometer that is mounted on or adjacent to the vibration actuator. Once activated, the controller generates low-level, low frequency electric signals that actuate a vibrator or vibrators which are connected to the hopper. The resulting induced vibrations of the hopper are continuously monitored via the accelerometer. The vibration frequency is gradually increased and the vibration amplitude automatically adjusted to maintain the optimal level of vibration at the hopper or hopper like structures. The measured vibration level is used to determine whether resonance or near-resonance conditions are achieved. Once this occurs, the vibration amplitude is increased to a level deemed suitable as the optimum required to induce bulk or dry material flow. During material discharge, the natural frequency of the hopper or hopper like structure is likely to vary. The device of the invention is designed to account for such situations by remaining active and will search for the new resonant frequency thus continually altering the excitation frequency such that true resonance is maintained throughout and thus achieving the optimal discharging process.

Because this controller induces the system to operate at optimal resonant frequencies it is likely that the vibrator being used could be smaller than those presently used to produce the same or similar results. The device is fully automated to account for variations in bulk and or granular material type and levels, hopper design and environmental conditions.

This device is designed to control vibration actuators capable of inducing a wide range of vibration signatures, frequencies and amplitudes into the hopper or hopper like structure.

This device can simultaneously control a number of actuators and sensors placed at various locations on the hopper or hopper like structure.

To restate this somewhat more fully, the controller undertakes the following:
1. It generates a constant amplitude low-level, electric signal that actuate a vibrator or vibrators which are connected to the hopper. The vibration frequency is gradually varied between two predetermined frequencies (sinusoidal sweep) while the resulting induced vibrations of the hopper are simultaneously monitored via the accelerometer.
2. The resulting vibration amplitude is stored in the controller's memory as a function of excitation frequency.
3. The controller detects the frequency corresponding to the maximum vibration response amplitude (resonant frequency) and generates a full-level signal at that frequency. This has been shown to induce bulk or dry material flow.
4. The controller also modulates the frequency of the excitation signal between two predetermined limits proportional to the main (centre) frequency in order to ensure that small shifts in the natural frequency of the structure are taken into account. This is sustained for a predetermined duration (say 1 minute)
5. A new set of frequency limits based on the last resonant frequency are generated and a new sinusoidal sweep (step 1) is undertaken over a predetermined frequency range congruent with the dynamic behaviour of the hopper.
6. Steps 1-5 are repeated continually in order to ensure that the optimal level of vibration at the hopper or hopper like structures is maintained.

The control software is fully automated and is designed so that it repeatedly seeks the highest amplitude resonant frequency of the structure and dwell at that frequency with a predetermined frequency modulation regime (optional) for a predetermined period. The resonant frequency is established using the swept-sinysoid method by which a sinusoidal vibration of continually varying frequency is induced into the structure while the structure's vibratory response is measured simultaneously. The most severe resonant frequency corresponds to the maximum response amplitude. The structure is then vibrated at the resonant frequency (which can be frequency-modulated to ensure that the region of frequencies around the resonant frequency is included.) This is sustained for a predetermined period after which the resonant frequency of the structure is re-measured using a reduced bandwidth sine sweep. This is to ensure that the excitation frequency always corresponds to the structure's actual resonant frequency which may vary as the material is discharged. This is repeated endlessly until the system is de-activated.

The software transmits the excitation signal via the controller's audio output channel and receives the accelerometer signal via the controller's input (line in) channel.

Configuration parameters that determine the functionality of the controller are as follows.
Minimum frequency of sine sweep [Hz]. Corresponds to a fraction of the lowest expected resonant frequency of the structure
Maximum frequency of sine sweep [Hz]. Corresponds to the highest expected severe resonant frequency of the structure
Initial sweep-up time [sec]. The time taken to initially sweep through the frequency range.
Settling time after the sweep [sec]. The time taken to extinguish the sweep signal after the sweep is complete.
Bandwidth of dwell oscillation [%]. Frequency modulation range as a proportion of the excitation frequency.
Time of dwell oscillation [sec]. Rate of frequency modulation.
Dwell duration [sec]. Period of resonant excitation before a new sinysoidal sweep is undertaken to update the structure's resonant frequency
Number of cycles. Can be set to infinite or to a predetermined number of cycled before the system stops automatically.
Lower frequency limit for consecutive sweeps [% of resonance frequency]. Low limit of frequency sweep for resonant frequency update.
Upper frequency limit for consecutive sweeps [% of resonance frequency]. High limit of frequency sweep for resonant frequency update.
Consecutive sweep-up time [sec]. The time taken to sweep through the frequency range.
Points of resonance search. Number of discrete frequency values over the frequency range.
Attenuation factor for the sinusoidal sweep. Corresponds to the amplitude of the swept sinusoidal vibrations.
Attenuation factor for the dwell. Corresponds to the amplitude of the resonant excitation vibrations.

The system is configured in such a way that the controller software will start automatically on completion of the operating system boot sequence. The software is loaded onto the controller's RAM which also hosts the system's operating system boot.

Because this controller induces the system to operate at optimal resonant frequencies it the vibrator being used could be smaller than those presently used to produce the same or similar results.

It will be appreciated that the device is fully automated to account for variations in bulk and or granular material type and levels, hopper and hopper like structure design and environmental conditions.

Further the system is portable, being able to be moved from hopper to hopper and as it searches for the resonant frequency and then maintain a check to see that the frequency being used is optimum, there is no wasted set-up time or calibration necessary when shifting from one hopper to an other.

Whilst there has been described herein one particular form of device of the invention and certain possible variations of this, it will be understood that these are exemplary only and variations can be made in the physical form, the method of connection to the hopper and to the operation of the measurement of the vibration without departing from the sprit and scope of the invention.

For example, the method of ascertaining the resonant frequency does not have to be done using sinusoidal sweeps but other methods and their associated algorithms can be used. Also reference to the operating system used and other specifics can be varied as well known in the art.

1-13. (canceled)

14. An apparatus for effecting optimum delivery of dry bulk material from a hopper, comprising:
means for providing vibratory stimulus to a hopper;
means for identifying a resonant frequency of the hopper and contents of the hopper; and,
means for automatically continuously varying a frequency of the vibratory stimulus for maintaining said frequency of the vibratory stimulus at, or close to, the resonant frequency of the hopper and its contents.

15. The apparatus for effecting optimum delivery of dry bulk material from a hopper according to claim 14, further comprising means for adjusting amplitude of vibration when the resonant frequency of the hopper and contents of the hopper is attained for providing optimum operating conditions.

16. The apparatus for effecting optimum delivery of dry bulk material from a hopper according to claim 14, further comprising an accelerometer for measuring vibration of said apparatus.

17. The apparatus for effecting optimum delivery of dry bulk material from a hopper according to claim 14, further comprising a sinusoidal sweep for ascertaining the resonant frequency of the hopper and contents of the hopper.

18. A method for effecting optimum delivery of dry bulk material from a hopper, comprising the steps of:
providing vibratory stimulus to a hopper;
identifying a resonant frequency of the hopper and contents of the hopper; and,
continuously varying a frequency of the vibratory stimulus to the hopper for maintaining the frequency of the vibratory stimulus to the hopper at, or close to, the resonant frequency of the hopper and the contents of the hopper.

19. The method for effecting optimum delivery of dry bulk material from a hopper according to claim 18, further comprising the step of:
adjusting amplitude of the vibratory stimulus when the resonant frequency of the hopper and the contents of the hopper is attained for providing optimum operating conditions.

20. The method for effecting optimum delivery of dry bulk material from a hopper according to claim 18, wherein said step of identifying a resonant frequency of the hopper and contents of the hopper includes using a sinusoidal sweep for ascertaining the resonant frequency.
